(19) United States
(12) Patent Application Publication
(10) Pub. No.: US 2013/0167660 A1
(43) Pub. Date: Jul. 4, 2013

(54) TORQUE SENSOR ARRANGEMENT HAVING AN INDEX MAGNET

(71) Applicants: Henrik Antoni, Freigericht (DE); Manfred Goll, Glauburg (DE); Thomas Krohn, Schwalbach (DE)

(72) Inventors: Henrik Antoni, Freigericht (DE); Manfred Goll, Glauburg (DE); Thomas Krohn, Schwalbach (DE)

(73) Assignee: CONTINENTAL TEVES AG & CO. OHG, Frankfurt (DE)

(21) Appl. No.: 13/811,951

(22) PCT Filed: Jul. 22, 2011
(86) PCT No.: PCT/EP2011/062670

§ 371 Date: Jan. 24, 2013

(30) Foreign Application Priority Data
Aug. 3, 2010 (DE) 10 2010 038 843.2
Dec. 23, 2010 (DE) 10 2010 064 145.6

(51) Int. Cl. G01L 3/00

(52) U.S. Cl. CPC G01L 3/00
USPC 73/862.193

(57) ABSTRACT

A sensor arrangement including a torque sensor for sensing the torque acting on a shaft. The torque sensor shaft includes two shaft segments, wherein a magnetic encoder is disposed on the first shaft segment and a stator packet is disposed on the second shaft segment, the stator packet having at least two magnetically conductive stator elements conducting the magnetic field generated by the magnetic encoder of the first shaft segment and guiding the field directly or indirectly to one or more magnetic field sensor elements for sensing the torque. An angle of rotation index unit detects and/or identifies the angular position of the shaft with respect to a defined angle of rotation and/or a defined range of angle of rotation. The angle of rotation index unit includes an index magnet attached to a carrier. The carrier connected to the magnetic encoder or at least to one of the stator elements.

### CROSS REFERENCE TO RELATED APPLICATIONS

This application is the U.S. National Phase Application of PCT/EP2011/062670, filed Jul. 22, 2011, which claims priority to German Patent Application Nos. 10 2010 038 843.2, filed Aug. 3, 2010 and 10 2010 064 145.6, filed Dec. 23, 2010, the contents of such applications being incorporated by reference herein.

### FIELD OF THE INVENTION

The invention relates to a sensor arrangement, comprising a torque sensor for detecting the torque acting on a shaft, the shaft of the torque sensor comprising two shaft segments, wherein a magnetic encoder is arranged on a first shaft segment and a stator packet with at least two magnetically conductive stator elements is arranged on a second shaft segment, wherein the magnetically conductive stator elements conduct a magnetic field produced by the magnetic encoder of the first shaft segment and feed it directly or indirectly to one or a plurality of magnetic field sensor elements for torque detection, and comprising a rotation angle index unit, which is designed so that it can detect and/or identify an angular position of the shaft relative to a defined rotation angle and/or a defined rotation angle range and to the use of the sensor arrangement in motor vehicles, in particular in the steering.

### BACKGROUND OF THE INVENTION

Sensor arrangements are known that comprise a torque sensor having a magnetic measurement principle and which additionally comprise a rotation angle index unit, as described for example in publication DE 10 2009 033 242 A1, which is incorporated by reference.

### SUMMARY OF THE INVENTION

An aspect of the invention is a sensor arrangement that comprises a torque sensor having a magnetic measurement principle and a rotation angle index unit, characterized in that the sensor arrangement is of relatively compact and relatively inexpensive form.

This is achieved with the sensor arrangement comprising a torque sensor for detecting the torque acting on a shaft, the shaft of the torque sensor comprising two shaft segments, wherein a magnetic encoder is arranged on a first shaft segment and a stator packet with at least two magnetically conductive stator elements is arranged on a second shaft segment, wherein the magnetically conductive stator elements conduct a magnetic field produced by the magnetic encoder of the first shaft segment and feed it directly or indirectly to one or a plurality of magnetic field sensor elements for torque detection, and comprising a rotation angle index unit, which is designed so that it can detect and/or identify an angular position of the shaft relative to a defined rotation angle and/or a defined rotation angle range, wherein the rotation angle index unit comprises an index magnet, which is attached to a support, and wherein the support is connected to either the magnetic encoder or at least one of the stator elements and the stator packet.

The sensor arrangement is preferably integrated into the steering of a motor vehicle for the measurement of the driver-side steering torque with the torque sensor and for detecting the steering rotation by means of the rotation angle index unit.

The stator packet preferably comprises at least two stator elements, which are at least partly encapsulated together, characterized in that the support is particularly attached to or connected to the plastic of said common encapsulation.

The index magnet is preferably in the form of a permanent magnet and the support is at least partly made of magnetically conductive material for guiding the magnetic field of the index magnet and/or for boosting the magnetic field of the index magnet. In particular, the support of magnetically conductive material is used to shield the magnetic circuits of the torque sensor and the rotation angle index unit from each other or to decouple them from each other or to substantially shield or isolate or decouple the magnetic circuit of the torque sensor from the magnet field of the index magnet.

Preferably, the torque sensor comprises a collector, especially comprising two magnetically conductive collector plates, which is arranged contactlessly relative to the stator packet and feeds the magnetic field to the at least one magnetic field sensor element.

It is advantageous that the stator elements each comprise a ring segment on which protruding fingers are arranged, especially fingers protruding axially relative to the shaft. The fingers of the two stator elements engage within each other particularly preferably without contact. The ring segments and the fingers are of magnetically conductive form.

The first and second shaft segments are preferably connected to each other by means of a torsion rod.

The support of the rotation angle index unit is preferably of annular or ring segment-shaped form and is joined, especially at its inner circumference, to the magnetic encoder or to at least one of the stator elements.

The rotation angle index unit preferably comprises at least one sensor element or magnet field sensor element, which is especially designed to switch, particularly preferably a switching hall sensor element.

The index magnet is preferably applied to the support by injection molding and is connected to the support in a form-fit manner, in particular by the index magnet engaging through recesses of the support or enclosing the support.

The index magnet is preferably in the form of a plastic body having embedded magnetic particles.

With regard to its magnetization, the index magnet advantageously comprises a main pole with two adjacent auxiliary poles, i.e. a North-South-North or South-North-South magnetization, which in particular impose two magnetic zone transitions or boundaries that can be detected by means of the magnetic field sensor element of the rotation angle index unit, as a result of which the detectability of said index magnets is relatively robust and flexible with regard to the length of the air gap between the index magnet and the magnetic field sensor element, i.e. relatively large air gap lengths are still possible. Alternatively, the magnetization of the index magnet is preferably in the form of a single North-South pole pair.

It is preferred that the index magnet is connected to the support by means of a connecting element in a form-fit manner, characterized in that the connecting element fixes or holds the index magnet on the support in a form-fit manner or presses it against the support and the connecting element itself is likewise connected to the support in a form-fit manner, especially by enclosing the support at at least one point and/or passing through the support, the pass-through taking place at one or more recesses of the support. The connecting element is particularly preferably of elastic form.

The form-fit connection is preferably fixed by hot peening.

The index magnet is alternatively preferably fixed onto the support by means of vulcanization, characterized in that the index magnet is particularly in the form of an elastomer body having magnetic particles.

It is preferred that the support of the rotation angle index unit is connected to the magnetic encoder or to the at least one stator element by means of at least one rivet, especially an ultrasonic rivet, or by hot peening.

It is advantageous that the support of the rotation angle index unit is at least partially encapsulated together with the index magnets and the stator elements or is at least partially injection molded with them in plastic for common attachment and to form a common assembly.

The term “connected” is preferably to be understood as also meaning the term “fixed”.

It is preferred that the index magnet comprises shaped elements, which are plugged through/around geometric shapes in the support to then be stamped/hot peened.

The index sensor advantageously comprises at least one magnetic field sensor element for detecting the index magnet.

It is preferred that the rotation angle index unit is designed so that switching information is generated for the associated magnetic field sensor element over a defined rotation range of the shaft within 360°, e.g. over a rotation range of ±10°, in particular for straight line motion, by means of the index magnet.

The index magnet is preferably of pressed or injection molded form and is completely made of hard magnetic material or comprises hard magnetic particles. In particular, with regard to its magnetization the index magnet comprises a single pole or a main pole with two auxiliary poles adjacent to the main pole on both sides—NSN or SNS—or alternatively a plurality of alternately magnetized poles—NSNSNSNSNSNSNS . . . —along an annular or ring segment-shaped line, characterized in that particularly preferably one pole is of different form than the other poles, especially in regard to its pole length, and the index magnet is formed as a rotation angle sensor in the context of the rotation angle index unit, most particularly preferably within 360°.

The invention relates moreover to the use of the sensor arrangement in motor vehicles, especially in the steering.

### BRIEF DESCRIPTION OF THE DRAWINGS

The invention is best understood from the following detailed description when read in connection with the accompanying drawing. Included in the drawing is the following figure:

FIGS. 1 through 7 show schematic example embodiments.

The figures show

FIGS. 1 through 5 various example embodiments of the support having index magnets and the rotation angle index unit,

FIG. 6 an example magnetic circuit of the torque sensor, and

FIG. 7 an example sensor arrangement having a torque sensor and a rotation angle index unit.

### DETAILED DESCRIPTION OF THE INVENTION

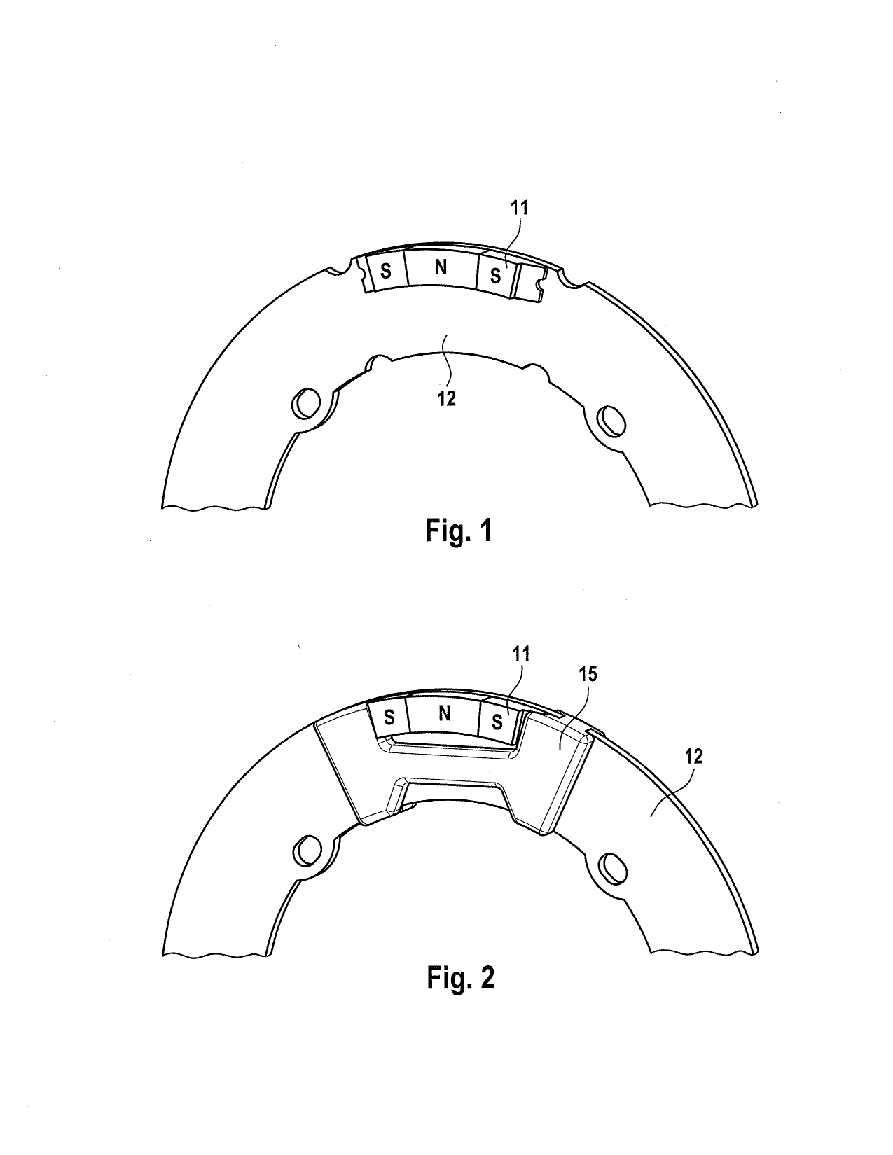

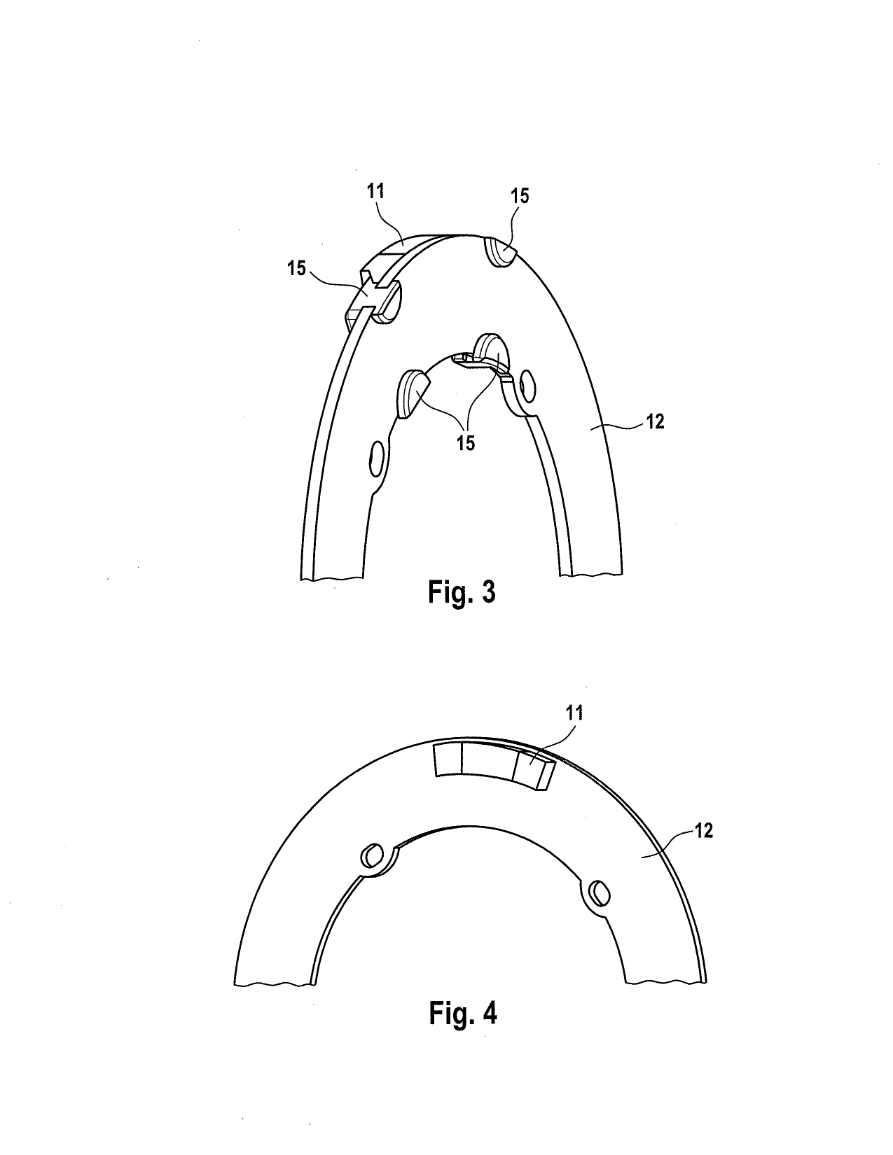

FIG. 1 shows index magnet 11, in the form of a permanent magnet with a South-North-South magnetization, i.e. a main pole N with two adjacent auxiliary poles, characterized in that the index magnet 11 is directly mounted on the support 12 of magnetically conductive material, e.g. steel, e.g. by gluing or alternatively by means of vulcanization. The support is also of annular form as in the following examples.

In FIGS. 2 and 3 index magnet 11, in the form of a relatively brittle permanent magnet, is fixed or mounted on the support in form-fit manner by means of a connecting element 15, which is of elastic form. The connecting element 15 encloses the support 12 at four points and is thus likewise joined to it in a form-fit manner, characterized in that the enclosing segments, which additionally engage in a recess on the edge of the support 12 in each case while engaging around it, have their shape fixed e.g. by hot peening. Said connection between the support 12 and the index magnet 11 is characterized by its high degree of robustness against temperature fluctuations. The relatively brittle magnetic material is connected to the relatively elastic connecting element 15, which according to the example has a thermal expansion characteristic matching that of the magnetic material of the index magnet 11. Said connection exhibits extremely little stress. The connecting element 15, which in turn is significantly more elastic than the magnetic material of the support 12, absorbs stresses between the support 12 and the connecting element 15.

The index magnet 11 is, according to FIGS. 4 and 5, sprayed directly onto the support 12. By means of holes and recesses 13 in the support 12, the magnetic material-plastic mixture of materials of the index magnet 11 is sprayed through or engages through said recesses 13 and index magnet 11 is formed as a form-fit element, e.g. in the form of a mushroom head, on the rear side of the support 12. Said formation is particularly efficient, because the production steps are kept relatively simple and no other components are necessary.

Instead of encapsulation, in an alternative, not illustrated example embodiment the index magnet comprises studs of a magnetic material-plastic mixture of materials on its rear side, which are pushed through holes in the support and then hot peened.

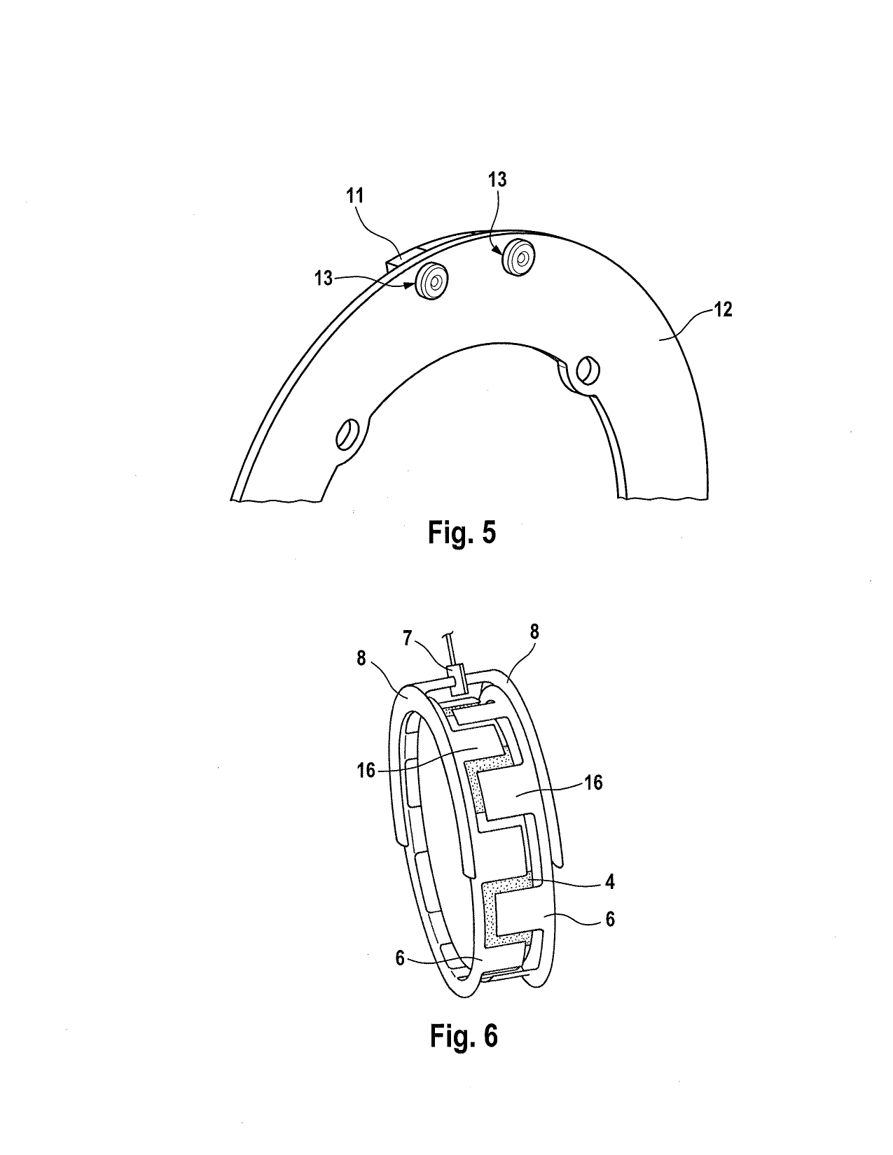

FIG. 6 shows an example of the magnetic circuit of the torque sensor, comprising the magnetic encoder 4, which is of annular form and is alternately magnetized with regard to its outer surface, stator elements 6 of the stator packet, which comprise fingers 16 on a ring protruding axially relative to the not illustrated shaft, and which, relative to the two stator elements 6, alternately engage between each other contactlessly and modulate the magnetic field of the encoder 4, and comprising two collector plates 8, which contactlessly receive the magnetic field modulated by the stator elements 6 and feed the same to the magnetic field sensor element 7 for torque measurement.

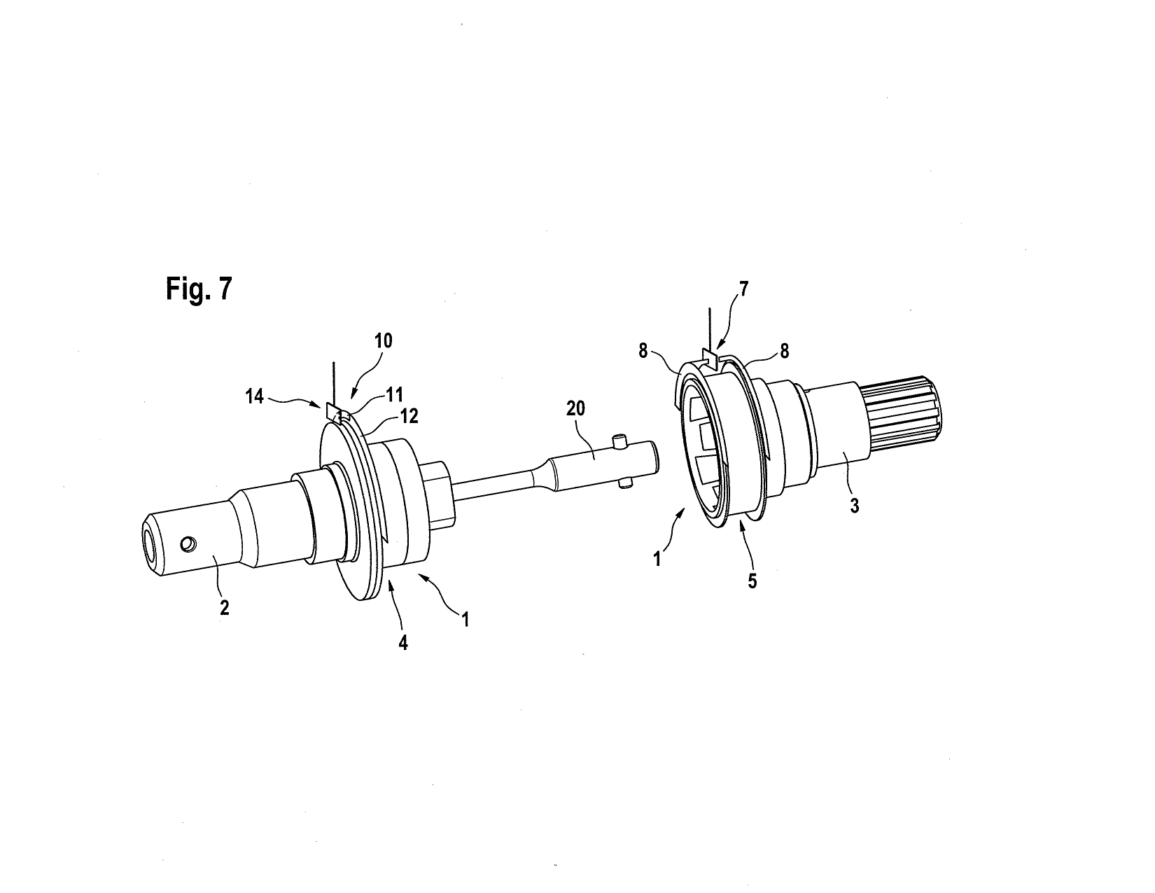

In FIG. 7 an example of a sensor arrangement is shown schematically in an exploded state. Torque sensor 1 comprises a first 2 and a second 3 shaft segment, characterized in that the annular magnetic encoder 4 is arranged on the first shaft segment 2 and stator packet 5 with the two stator elements is arranged on the second shaft segment 3, said stator elements being able to be seen better using FIG. 6. The two shaft segments 2, 3 are joined to each other by a torsion rod 20. The stator elements of the stator packet 5 have contactlessly associated collector plates 8, which feed the magnetic field, which is generated by the encoder 4 and modulated by the stator packet 5, to the magnetic field sensor element 7 of the torque sensor 1. The rotation angle index unit 10 comprises the support 12 of magnetically conductive material for magnetic shielding of the magnetic field of the index magnet 11 relative to the torque sensor 1, and comprises a switching magnetic field sensor element 14, which detects the magnetic field generated by the index magnet within a defined angular range. The index magnet 11 is, according to the example, attached or fixed directly onto the support 12 in a form-fit manner.

1.-12. (canceled)

13. A sensor arrangement, comprising a torque sensor for detecting the torque acting on a shaft, the shaft of the torque sensor comprising two shaft segments, wherein a magnetic encoder is arranged on a first shaft segment and a stator packet with at least two magnetically conductive stator elements is arranged on a second shaft segment, wherein the magnetically conductive stator elements conduct a magnetic field produced by the magnetic encoder of the first shaft segment and feed it directly or indirectly to one or a plurality of magnetic field sensor elements for torque detection, and comprising a rotation angle index unit, which is designed so that it can detect and/or identify an angular position of the shaft relative to a defined rotation angle and/or a defined rotation angle range,
wherein the rotation angle index unit comprises an index magnet, which is attached to a support, and wherein the support is connected to either the magnetic encoder or at least one of the stator elements and the stator packet.

14. The sensor arrangement according to claim 13, wherein the index magnet is in the form of a permanent magnet and the support is made of magnetically conductive material for guiding the magnetic field of the index magnet.

15. The sensor arrangement according to claim 13, wherein the support of the rotation angle index unit is of annular or ring segment form and is connected to the magnetic encoder or at least one of the stator elements at an inner circumference thereof.

16. The sensor arrangement according to claim 13, wherein the rotation angle index unit comprises at least one sensor element.

17. The sensor arrangement according to claim 16, wherein the sensor element is a switching hall sensor element.

18. The sensor arrangement according to claim 13, wherein the index magnet is applied to the support by injection molding and is connected to the support in a form-fit manner, by the index magnet passing through recesses of the support or enclosing the support.

19. The sensor arrangement according to claim 13, wherein the index magnet is connected to the support by a connecting element in a form-fit manner, such that the connecting element fixes the index magnet on the support in a form-fit manner and the connecting element itself is likewise joined to the support in a form-fit manner, by enclosing the support at at least one point and/or by passing through the support.

20. The sensor arrangement according to claim 19, wherein the connecting element is of elastic form.

21. The sensor arrangement according to claim 19, wherein the at least one form-fit connection is fixed by hot peening.

22. The sensor arrangement according to claim 13, wherein the index magnet is fixed to the support by vulcanization, and wherein the index magnet is in the form of an elastomer body having magnetic particles.

23. The sensor arrangement according to claim 13, wherein the support of the rotation angle index unit is connected to the magnetic encoder or to the at least one stator element by at least one rivet, or by hot peening.

24. The sensor arrangement according to claim 23, wherein the at least one rivet is an ultrasonic rivet.

25. The sensor arrangement according to claim 13, wherein the support of the rotation angle index unit is at least partly encapsulated together with the index magnet and the stator elements for common fastening to form a common assembly.

26. A use of the sensor arrangement in a motor vehicle steering system, comprising a torque sensor for detecting the torque acting on a shaft, the shaft of the torque sensor comprising two shaft segments, wherein a magnetic encoder is arranged on a first shaft segment and a stator packet with at least two magnetically conductive stator elements is arranged on a second shaft segment, wherein the magnetically conductive stator elements conduct a magnetic field produced by the magnetic encoder of the first shaft segment and feed it directly or indirectly to one or a plurality of magnetic field sensor elements for torque detection, and comprising a rotation angle index unit, which is designed so that it can detect and/or identify an angular position of the shaft relative to a defined rotation angle and/or a defined rotation angle range,
wherein the rotation angle index unit comprises an index magnet, which is attached to a support, and wherein the support is connected to either the magnetic encoder or at least one of the stator elements and the stator packet.
